(19) United States
(12) Patent Application Publication
(10) Pub. No.: US 2013/0036732 A1
(43) Pub. Date: Feb. 14, 2013

(54) ROTARY TYPE STIRLING ENGINE FOR GREEN GROWTH

(71) Applicant: Gook Sun Shin, Gimhae-si (KR)

(72) Inventor: Gook Sun Shin, Gimhae-si (KR)

(21) Appl. No.: 13/521,682

(22) PCT Filed: Dec. 9, 2010
(86) PCT No.: PCT/KR10/08782

§ 371 Date: Jul. 11, 2012

(30) Foreign Application Priority Data
Jan. 11, 2010 (KR) 10-2010-0002251

(51) Int. Cl. F02G 1/043

(52) U.S. Cl. 60/517

(57) ABSTRACT

The present invention relates to a Stirling engine in which power is generated using a variation in pressure generated by continuously performing periodical heating and cooling operations when a heat transfer medium is stored in a sealed inner space. The Stirling engine generates power for rotating an output shaft (12) through the expansion and contraction of the heat transfer medium sealed and received in a space partitioned by a baffle (40) within an inner space (21) of a housing (20). Thus, when compared to the prior art, the Stirling engine of the present invention may be more easily manufactured. Also, the heat transfer medium for generating power may be easily managed, maintained, and repaired. In addition, since the heat circulation structure is simple, the Stirling engine of the present invention can achieve relatively higher thermal efficiency than those of the prior art.

### TECHNICAL FIELD

The present invention relates to a rotary type Stirling engine for green growth, and more particularly, to such a rotary type Stirling engine for green growth, which can be positively utilized in a renewable energy application field by improving a conventional Stirling engine in which power is produced using a change in the pressure of a heat transfer medium occurring by continuously performing a periodic heating and cooling in a state in which the heat transfer medium is stored in a sealed inner space.

### BACKGROUND ART

In general, a demand for green growth is increasing as the global consensus for environmental protection spreads. In addition, such green growth requires high utilization of new renewable energy that is researched in a variety of fields including solar power, wind power, hydropower, biomass, etc.

In the meantime, an interest on utility of the renewable energy is growing increasingly due to continuous high oil prices along with an appearance of the environmental pollution problems. Thus, the present inventor has taken an interest in an Stirling engine that can employ gas fuel and solid fuel together with liquid fuel of petroleum as well as can apply various energy such as waste heat generated from a power plant and a factory, geothermy, solar heat, and the like as a power source in utilization of the renewable energy.

Such a Stirling engine is disclosed in Korean Patent Laid-Open Publication No. 10-2002-0016696 entitled “Method of Controlling Power Output of a Stirling Engine”, Korean Patent Registration No. 10-0699400 entitled “Folded Guide Link Stirling Engine”, Korean Patent Registration No. 10-0743954 entitled “Stirling Engine”, and Korean Patent Laid-Open Publication No. 10-2006-0111553 entitled “Stirling Engine Assembly”. As disclosed in the above patent documents, the Stirling engine is a heat regenerative external combustion engine which basically includes a displacer and a piston accommodated in a cylinder, and is configured such that an expansion space partitioned between a head portion of the cylinder and the displacer and a compression space partitioned between the displacer and the piston fluidically communicate with each other through a regenerator, thereby producing power by heating the working gas contained in the cylinder at the expansion space side and cooling the working gas at the compression space side.

However, such a Stirling engine entails mechanical and economic problems in that vibration occurs upon the operation thereof by the moment of inertia of the piston, and the manufacturing cost is increased due to friction and leakage at a piston contact portion, and complexity of a driving mechanism. In particular, for a Stirling engine that is operated in a low-temperature heat source having a low energy density, minimization of friction loss and high speed rotation are important. Thus, in case of adopting a reciprocating engine, the above mechanical properties become key barrier factors.

In the meantime, U.S. Pat. No. 4,044,559 entitled “Rotary Closed Series Cycle Engine System” proposes a technology in which vanes are mounted around a drive shaft and a rotor is eccentrically disposed within a cylindrical housing, and a hot side manifold and a cool side manifold are coupled to the housing so that heated gas is introduced into the housing through the hot side manifold to rotate the rotor while forcibly pushing the vanes to cause the drive shaft engaged to the rotor to be rotated by the working gas flowing to the outside through the cool side manifold.

Such a Stirling engine is a technology that is proposed by applying a vane type motor as described in Korean Patent Laid-Open Publication No. 10-1998-048337 entitled “Rotary Type Internal Combustion Engine” and Korean Patent Laid-Open Publication No. 10-2005-0032151 entitled “Improvement in Internal Combustion Engine with Means of Plural Swinging Vanes”. However, this Stirling engine encounters a problem in that a heating portion and a cooling portion are installed on the outer circumference of a housing to cause gas to flow from the heating portion to the housing to move the vanes and the gas to be discharged to the cooling portion, so that the stable flow of the gas is impossible or difficult to maintain in rotation of the drive shaft. For example, such a proposed Stirling engine has a drawback in that it is impossible to continuously provide the flow of gas allowing the pressure of gas introduced into the housing from the heating portion to act on the cooling portion.

### DISCLOSURE OF INVENTION

### Technical Problem

Accordingly, the present invention has been made in order to solve the above-mentioned problems occurring in the prior art, and it is an object of the present invention is to provide a novel rotary type Stirling engine for green growth, which can effectively reduce a loss of vibration and friction that may occur by improving a conventional Stirling engine in which power is produced using a change in the pressure of a heat transfer medium occurring by continuously performing a periodic heating and cooling in a state in which the heat transfer medium is stored in a sealed inner space, thereby further increasing the utilization in a renewable energy application field.

In particular, another object of the present invention is to provide a novel rotary type Stirling engine for green growth, which can be relatively easily manufactured as compared to the prior art by breaking from a Stirling engine system adopting the conventional vane motor principle, can facilitate the management and maintenance of a heat transfer medium to produce power, and can increase the thermal efficiency.

### TECHNICAL SOLUTION

To achieve the above object, the present invention provides a rotary type Stirling engine for green growth, in which power is produced using a change in the pressure of a heat transfer medium occurring by continuously performing a periodic heating and cooling in a state in which the heat transfer medium is stored in a sealed inner space 21, the Stirling engine including:

a hollow cylindrical housing 20 having an inner circumferential surface 22 defining the inner space 21 therein and an outer circumferential surface 24, and including an output shaft 12 coupled thereto so as to extend outwardly therefrom to have an eccentricity amount, Δl on a reference central axis CL, the output shaft being configured to allow power produced to be transferred to the outside and the housing being hermetically sealed to prevent the heat transfer medium stored in the inner space 21 from leaking to the outside;

a rotor 30 coupled to the output shaft 12 within the housing 20; and

a baffle 40 coupled to the outer circumference of the rotor 30 in such a manner as to be arranged equidistantly in a circumferential direction of the rotor 30 so that the inner space 21 is partitioned into a plurality of regions by the baffle to allow the heat transfer medium to be uniformly received in the regions, the baffle being coupled to the outer circumference of the rotor 30 in such a manner as to be variable with respect to the rotary center C2 of the rotor 30 in a radial direction of the rotor 30 so that the baffle is maintained in a stat of being in close contact with the inner circumferential surface 22 of the housing 20 and the inner space 21 is partitioned into a plurality regions by the baffle 40 to cause working fluid received in one of the partitioned regions to be prevented from flowing into another partitioned region,

whereby heating and cooling are performed on the outer circumferential surface 24 of the housing 20 based on the reference central axis CL so that the heat transfer medium sealingly received in the inner space 21 of the housing 20 is expanded and contracted to forcibly push the baffle 40 to thereby produce power for rotating the output shaft 12 through the rotor 30.

In the rotary type Stirling engine for green growth according to the present invention, the rotor 30 may include one or more recesses 36 formed therein in such a manner as to be arranged in parallel with a radial direction of the center C2 of the rotor 30, and the baffle 40 includes one or more blades 42 and one or more elastic element 44 each of which is connected to each blade, each blade 42 being brought into close contact at one end thereof with the inner circumferential surface of the housing 20 and being inserted at the other end thereof into the recess 36 of the rotor so that the blade is slidingly coupled to the rotor 30 in a radial direction of the rotor, and each elastic element 44 being disposed in the recess so that an elastic force generated by the elastic element 44 acts on the blade 42 to cause the blade to be forcibly pushed and come into close contact with the inner circumferential surface 22 of the housing 20.

The rotary type Stirling engine for green growth according to the present invention may further include a heat exchange division member 60 configured to divide an outer space defined on the outer circumference of the housing 20 into a heating region 61 for performing a heating operation and a cooling region 61′ for performing a cooling operation based on the reference central axis CL.

In the rotary type Stirling engine for green growth according to the present invention, the housing 20 may further include a plurality of heat radiating fins 28 and 72 extending protrudingly radially from the outer circumferential surface 24 thereof in such a manner as to be spaced apart from one another at equal intervals.

### Advantageous Effects

The rotary type Stirling engine for green growth of the present invention generates power for rotating an output shaft 12 through the expansion and contraction of the heat transfer medium sealingly received in a space partitioned by a baffle 40 within an sealed inner space 21 of the housing 20 unlike a conventional Stirling engine that produces power for rotating an output shaft (driving shaft) through circulation of a heat transfer medium. Thus, the Stirling engine of the present invention can be relatively easily manufactured as compared to the prior art. In addition, the management and maintenance of the heat transfer medium for generating power is facilitated. Moreover, since the heat circulation structure is simple, the Stirling engine of the present invention can achieve higher thermal efficiency than that of the prior art. Further, since the Stirling engine according to the present invention can reduce and control the compression ratio, a high precision sealing related problem can be overcome to some extent.

### BRIEF DESCRIPTION OF THE DRAWINGS

FIG. 1 is a horizontal cross-sectional view illustrating a rotary type Stirling engine for green growth, which is cut in a radial direction, according to a technical spirit of the present invention;

FIG. 2 is a schematic cross-sectional view taken along the line A-A′ in FIG. 1;

FIG. 3 is a horizontal cross-sectional view illustrating a rotary type Stirling engine for green growth, which is cut in a radial direction, according to a preferred embodiment of the present invention;

FIG. 4 is a schematic perspective view illustrating the rotary type Stirling engine for green growth shown in FIG. 3;

FIG. 5 is a horizontal cross-sectional view illustrating a rotary type Stirling engine for green growth, which is cut in a radial direction, according to another preferred embodiment of the present invention;

FIG. 6 is a horizontal cross-sectional view illustrating a rotary type Stirling engine for green growth, which is cut in a radial direction, according to still another preferred embodiment of the present invention; and

FIG. 7 is a schematic perspective view of the rotary type Stirling engine for green growth shown in FIG. 6.

### BEST MODE FOR CARRYING OUT THE INVENTION

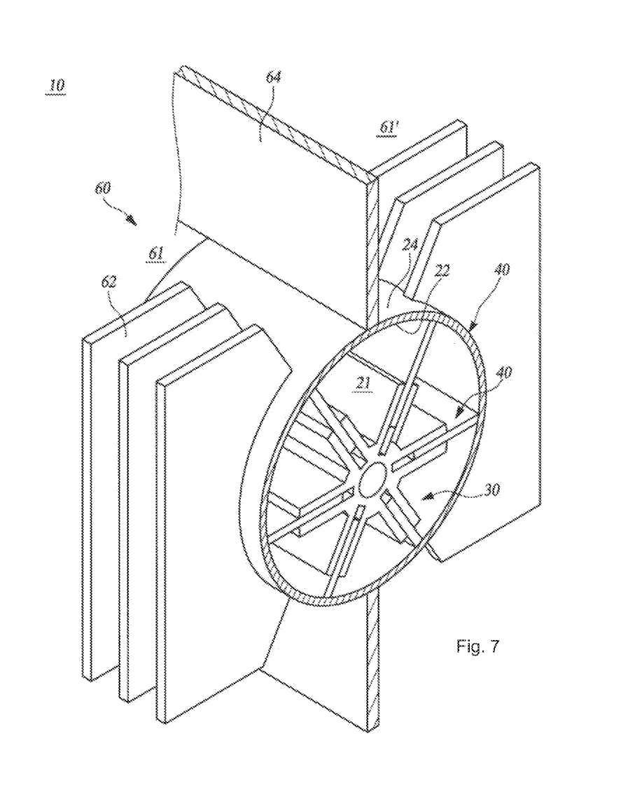

Hereinafter, the preferred embodiments of the present invention will be described in further detail with reference to FIGS. 32 to 7.

In the meantime, in the detailed description and the accompanying drawings, illustration and explanation on the construction and operation of the Stirling engine, the prior art, and portions which those skilled in the art can easily understand will be omitted to avoid redundancy. In particular, in the detailed description and the accompanying drawings, illustration and explanation on the detailed technical construction and operation of elements, which have no direct connection with the technical features of the present invention, will be omitted, and only the technical constructions directly related with the present invention will be briefly illustrated and explained.

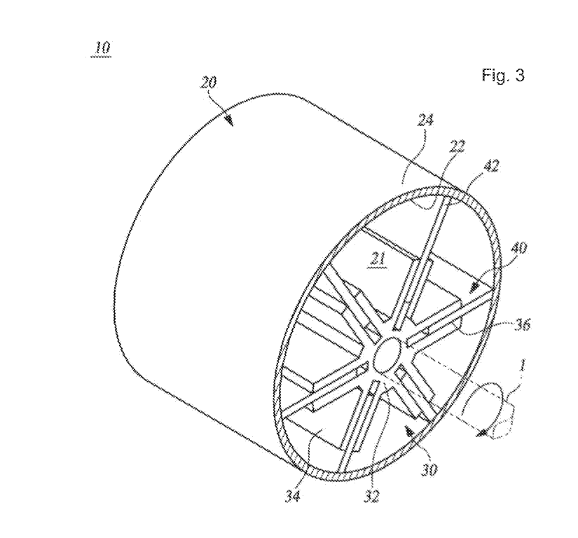

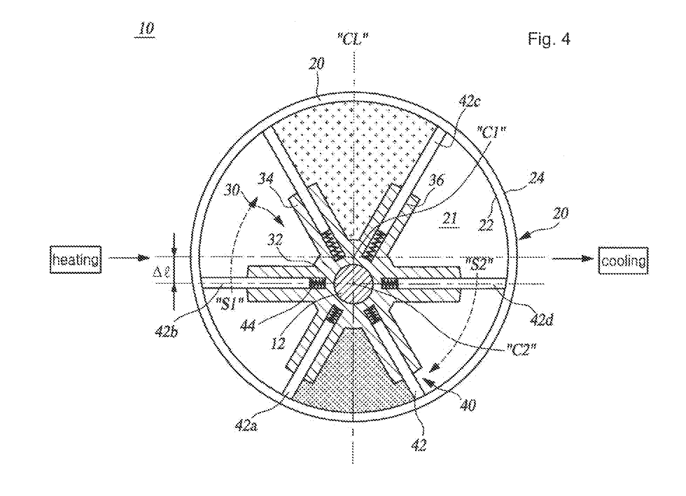

FIG. 3 is a horizontal cross-sectional view illustrating a rotary type Stirling engine for green growth, which is cut in a radial direction, according to a preferred embodiment of the present invention, and FIG. 4 is a schematic perspective view illustrating the rotary type Stirling engine for green growth shown in FIG. 3.

Referring to FIGS. 3 and 4, a rotary type Stirling engine 10 for green growth according to a preferred embodiment of the present invention includes a hollow cylindrical housing 20, a rotor 30, and a baffle 40 so as to produce power using a change in the pressure of a heat transfer medium occurring by continuously performing a periodic heating and cooling in a state in which the heat transfer medium is stored in a sealed inner space 21.

In the rotary type Stirling engine 10 for green growth according to this embodiment, the housing 20 has an inner circumferential surface 22 and an outer circumferential surface 24. The inner circumferential surface 22 defines the inner space 21 in the housing 20. The housing 20 includes an output shaft 12 coupled thereto so as to extend outwardly therefrom to have an eccentricity amount, Δl on a reference central axis CL. The output shaft is configured to allow power produced to be transferred to the outside and the housing is hermetically sealed to prevent the heat transfer medium stored in the inner space 21 from leaking to the outside. In this embodiment, the housing 20 has a substantially radially circular cross-section.

In addition, the rotor 30 is coupled to the output shaft 12 within the housing 20.

The rotor 30 has the same rotary center C2 as that of the output shaft 12, so that the rotary center C2 of the rotor 30 is deviated from a center C1 of the housing 20 by an eccentricity amount Δl. Such a rotor 30 constitutes the installation structure of the baffle 40 so that when the working force of the heat transfer medium acts on the baffle 40, it is effectively transferred to the output shaft 12. In this embodiment, the rotor 30 includes a hub 32 coupled to the output shaft 12 to have a stable thickness around the output shaft 12, and a plurality of bosses 34 extending protrudingly radially from the hub 32 in such a manner as to arranged in parallel with a radial direction of the rotary center C2 of the rotor 30. In this case, each boss 34 has a recess 36 formed therein in such a manner as to be arranged in parallel with a radial direction of the rotary center C2 of the rotor 30 so that the baffle 40 is fittingly inserted into the recess 36 in order to stably support the baffle 40.

Meanwhile, in this embodiment, the baffle 40 is coupled to the outer circumference of the rotor 30 in such a manner as to be arranged equidistantly in a circumferential direction of the rotor 30 so that the inner space 21 is partitioned into a plurality of regions by the baffle 40 to allow the heat transfer medium to be uniformly received in the regions. In addition, the baffle 40 is coupled to the outer circumference of the rotor 30 in such a manner as to be variable with respect to the rotary center C2 of the rotor 30 in a radial direction of the rotor 30 so that the baffle is maintained in a stat of being in close contact with the inner circumferential surface 22 of the housing 20 and the inner space 21 is partitioned into a plurality regions by the baffle 40 to cause working fluid received in one of the partitioned regions to be prevented from flowing into another partitioned region. Particularly, in this embodiment, the baffle 40 includes a plurality of blades 42 and a plurality of elastic element 44 each of which is connected to each blade. Each blade 42 is brought into close contact at one end thereof with the inner circumferential surface of the housing 20 and is inserted at the other end thereof into the recess 36 of the rotor so that the blade is slidingly coupled to the rotor 30 in a radial direction of the rotor. Further, each elastic element 44 is disposed in the recess so that an elastic force generated by the elastic element 44 acts on the blade 42 to cause the blade to be forcibly pushed and come into close contact with the inner circumferential surface 22 of the housing 20. In this embodiment, an example is described and illustrated in which a spring is applied as the elastic element 44. When it is rotated by the heat transfer medium, such a baffle 40 continues to be maintained in a state of being close contact with the inner circumferential surface 22 of the housing 20 while extending elastically in a radial direction with respect to the rotor 30 so that the heat transfer medium contained in each partitioned zone of the inner space is prevented from leaking into another partitioned zone.

In the meantime, the rotation of the rotary type Stirling engine 10 for green growth according to this embodiment is theoretically based on the gas state equation (PV=nRT). In other words, in this embodiment, the transfer amount of heat is defined as follows. The amount of heat introduced into one side of the housing 20 and that of heat discharged from the other side of the housing 20 based on the reference central axis CL of the housing 20 are the same as each other. Each space region partitioned by the baffle 40 is filled with a certain amount of gas (i.e., heat transfer medium) in order to allow the baffle to be moved only by a minute difference in the temperature between one side and the other side of the housing 20. In the case where there is a great difference in the temperature of the gas, although a certain amount of gas is not filled in each partitioned space region, the baffle 40 is rotated by its irregular vibration as its force being not constant. On the other hand, in the case where there is a small difference in the temperature between one side and the other side of the housing 20, the baffle 40 is finally stopped in rotation. Thus, a certain amount of air is filled in each partitioned space region. Herein, the certain amount means that a value obtained by multiplying pressure by volume is constant (PV=constant).

The rotary type Stirling engine 10 for green growth according to this embodiment is driven to produce power by a difference in the pressure of each partitioned space region according to a difference in the temperature between one side and the other side of the housing 20 based on the reference central axis CL. In addition, a force of the motor is generated as a product of the difference in the pressure and an area corresponding to the eccentricity amount, Δl from the inner circumferential surface 22 of the housing 20 in the space partitioned by the baffle 40. Thus, the driving force of the rotary type Stirling engine 10 for green growth according to this embodiment can represented by a product of an area formed by the eccentricity amount, Δl and the width of the inner space 21 in a lengthwise direction of the motor, and an average difference in the pressure between the left side and the right side of the reference central axis CL. The torque moment is obtained by multiplying the product of the area and the average difference in the pressure by a distance from an intermediate point of the eccentricity amount, Δl to the center C2 of the rotor 30 when comparing the eccentricity amount, Δl with the inner circumferential surface 22 of the housing 20

In other words, the force-acting area=(large radius−small radius)×width of the inner space (i.e., length of the housing),

Force=average difference in the pressure between the left side and the right side of the reference central axis CL, and

Arm length=(eccentricity amount(Δl)+small radius), and hence

Torque moment=(large radius−small radius)×width×average difference in the pressure between the left side and the right side of the reference central axis CL×average radius (eccentricity amount (Δl)+small radius).

The operation of the rotary type Stirling engine 10 for green growth according to this embodiment will be described hereinafter with reference to FIG. 3.

Referring back to FIG. 3, in this embodiment, a left partitioned space S1 of the housing 20 corresponds to a heating region, and a right partitioned space S2 of the housing 20 corresponds to a cooling region. The heat transfer medium (i.e., gas) sealingly contained in the space S1 partitioned as the heating region receives heat from the left side of the housing to cause the temperature and pressure of the heat transfer medium inside the space S1 to increase. At this time, there occurs a difference in the area between two blades 42a and 42b defining a boundary of the space S1 so that the rotation of the baffle is performed in the direction of a blade 42b having a larger area.

Further, the pressure of the expanded heat transfer medium begins to gradually decrease by the cooling operation performed at the other side of the housing 20 at the upper center portion of the inside of the housing 20, and the heat transfer medium sealingly contained in the space S2 partitioned as the cooling region is cooled rapidly to cause the temperature and pressure of the heat transfer medium inside the space S1 to decrease. Thus, there occurs a difference in the area between two blades 42c and 42d defining a boundary of the space S2 so that the rotation of the baffle is performed in the direction of a blade 42d having a smaller area.

As such, the space S1 partitioned as the heating region and its adjoining space, and the space S2 partitioned as the cooling region and its adjoining space forms a single flow space to generate a pressure deviation so that the rotor 30 is continuously rotated to achieve a continuous rotation of the output shaft 12 to produce power.

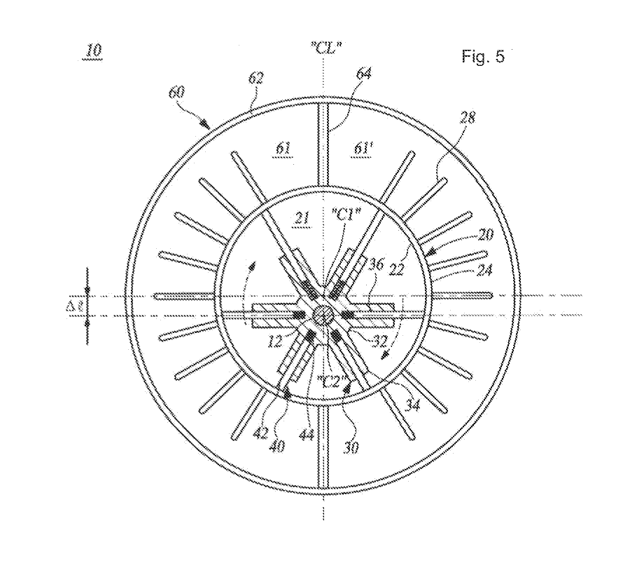

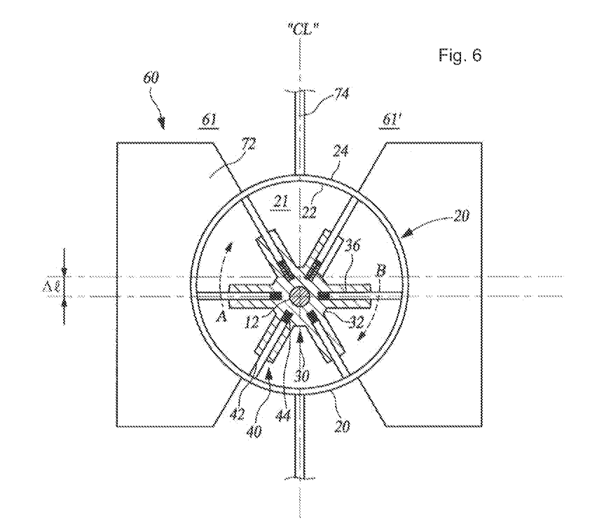

FIG. 5 is a horizontal cross-sectional view illustrating a rotary type Stirling engine for green growth, which is cut in a radial direction, according to another preferred embodiment of the present invention, FIG. 6 is a horizontal cross-sectional view illustrating a rotary type Stirling engine for green growth, which is cut in a radial direction, according to still another preferred embodiment of the present invention, and FIG. 7 is a schematic perspective view of the rotary type Stirling engine for green growth shown in FIG. 6.

Referring to FIG. 5, the rotary type Stirling engine 10 for green growth according to another preferred embodiment of the present invention further includes a heat exchange division member 60 and a heat radiating fin 28 to increase the thermal efficiency. The Stirling engine 10 in this embodiment can be applied to power plant facilities employing waste heat generated from a purification facility of a petrochemical plant, waste steam generated from a thermal power station, radiation of a nuclear power plant, etc.

In such a rotary type Stirling engine 10 for green growth, the heat exchange division member 60 divides an outer space defined on the outer circumference of the housing 20 into a heating region 61 for performing a heating operation and a cooling region 61′ for performing a cooling operation based on the reference central axis CL. In addition, the heat radiating fin 28 is provided in plural number on the housing 20. The plurality of heat radiating fins 28 extends protrudingly radially from the outer circumferential surface 24 of the housing 20 in such a manner as to be spaced apart from one another at equal intervals.

In the rotary type Stirling engine 10 for green growth of this embodiment, the heat exchange division member 60 consists of an outer shell 62 formed with regions 61 and 61′ into which fluid for heat exchange with the heat transfer medium contained in the housing 20 can be introduced, and a partition wall 64 disposed within the outer shell 62 so as to divide the outer space of the housing 20 into the left and right regions 61 and 61′ based on the reference central axis CL. Besides, the plurality of heat radiating fins 28 extends protrudingly radially from the outer circumferential surface 24 of the housing 20.

In such a rotary type Stirling engine 10 for green growth, the plurality of heat radiating fins 28 is formed in parallel with one another in a lengthwise of the housing 20 such that fluid flows through the heat exchange division member 60. That is, hot fluid flows in a lengthwise direction of the housing 20 in the left heating region 61 of the housing 20 and cold fluid flows in a lengthwise direction of the housing 20 in the right cooling region 61′ of the housing 20 based on the reference central axis CL.

Referring to FIGS. 6 and 7, the rotary type Stirling engine 10 for green growth according to this embodiment includes a heat exchange division member 60 similarly to the Stirling engine 10 shown in FIG. 5. The heat exchange division member 60 features that it divides an outer space on the outer circumference of the housing 20 into a heating region 61 for performing a heating operation and a cooling region 61′ for performing a cooling operation based on the reference central axis CL so that the regions into which fluid can be introduced are not limited. Such a rotary type Stirling engine 10 for green growth can be applied to a desert where scorching direct sunlight pours down and the temperature of air is relatively low, a place where radiant heat is strong and the temperature is low, and the like.

The heat exchange division member 60 of such a rotary type Stirling engine 10 for green growth according to this embodiment includes a partition wall 64 disposed on the outer circumferential surface 24 of the housing 20 so as to divide the outer space of the housing 20 into a left heating region for performing a heating operation and a right cooling region 61′ for performing a cooling operation based on the reference central axis CL so that fluid acts on the housing 20 entirely in each region. The rotary type Stirling engine for green growth according to this embodiment includes heat radiating fins 72 disposed in parallel with the reference central axis CL on the outer circumferential surface 24 of the housing 20 to increase the heat exchange efficiency.

While the rotary type Stirling engine for green growth according to the preferred embodiments of the present invention have been described and illustrated in connection with specific exemplary embodiments with reference to the accompanying drawings, it will be readily appreciated by those skilled in the art that it is merely illustrative of the preferred embodiments of the present invention and various modifications and changes can be made thereto within the technical spirit and scope of the present invention.

### BEST MODE

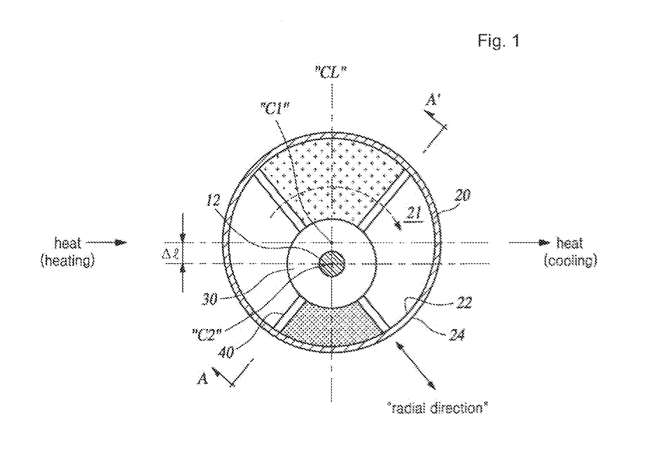

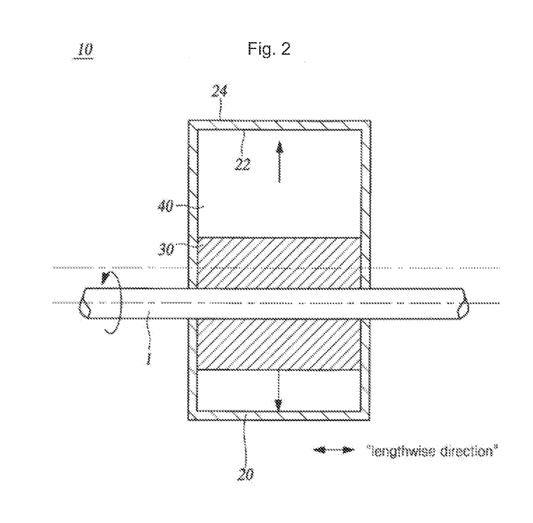

FIG. 1 is a horizontal cross-sectional view illustrating a rotary type Stirling engine for green growth, which is cut in a radial direction, according to a technical spirit of the present invention, and FIG. 2 is a schematic cross-sectional view taken along the line A-A′ in FIG. 1.

Referring to FIGS. 1 and 2, the technical feature of the rotary type Stirling engine 10 for green growth according to the present invention resides in that the Stirling engine generates power for rotating an output shaft 12 through the expansion and contraction of the heat transfer medium within an sealed inner space 21 of the housing 20 unlike a conventional Stirling engine that produces power through circulation of a heat transfer medium.

The rotary type Stirling engine 10 for green growth according to the present invention allows the sealed inner space 21 of the housing 20 to be partitioned into a plurality of regions by the baffle 40 and simultaneously the heat transfer medium to be uniformly distributed to cause heating and cooling to be performed based on the reference central axis CL, so that the baffle 40 is forcibly pushed through the expansion and contraction of the heat transfer medium sealingly received within the inner space 21 of the housing 20 to produce power for rotating an output shaft 12 through the rotor 30.

More specifically, referring back to FIGS. 1 and 2, the rotary type Stirling engine 10 for green growth according to the present invention includes a hollow cylindrical housing 20, a rotor 30, and a baffle 40 so as to produce power using a change in the pressure of a heat transfer medium occurring by continuously performing a periodic heating and cooling in a state in which the heat transfer medium is stored in a sealed inner space 21.

In this case, the rotary type Stirling engine 10 according to the present invention has a housing 20 specially designed to produce power for rotating the output shaft through the expansion and contraction of the heat transfer medium within the sealed inner space. That is, the housing has an inner circumferential surface 22 and an outer circumferential surface 24. The inner circumferential surface 22 defines the inner space 21 in the housing 20. The housing 20 includes an output shaft 12 coupled thereto so as to extend outwardly therefrom to have an eccentricity amount Δl on a reference central axis CL. That is, the center C2 of the rotor 30 is deviated from the center C1 of the housing 20 by an eccentricity amount Δl. The output shaft is configured to allow power produced to be transferred to the outside and the housing is hermetically sealed to prevent the heat transfer medium stored in the inner space 21 from leaking to the outside. The housing 20 may have a substantially radially circular or elliptical cross-section which is perpendicular to the lengthwise direction of the housing, but preferably has a radially circular cross-sectional. In addition, the housing 20 may be formed to have various lengths in a lengthwise direction thereof, and may be constructed such that a plurality of housings 20 (including other elements) is coupled to a single output shaft 12.

In the meantime, although not shown, the housing 20 may be provided with a structure such as a bearing or the like for rotatably supporting the output shaft 12, the rotor 20 and the baffle 40, a structure such as a seal or the like for hermetically sealing the heat transfer medium received in the housing, and a combination of the rotatably supporting structure and the hermetically sealing structure. The rotatably supporting structure and the hermetically sealing structure will be able to be implemented by selectively using a variety of kinds of techniques well known in the art depending on the need.

In the rotary type Stirling engine 10 for green growth according to this embodiment, the rotor 30 is coupled to the output shaft 12 within the housing 20. That is, the rotor 30 has the same rotary center C2 as that of the output shaft 12. Such a rotor 30 constitutes the installation structure of the baffle 40 so that when the working force of the heat transfer medium acts on the baffle 40, it is effectively transferred to the output shaft 12. Further, the rotor 30 may be constructed by applying various techniques such as serration, spline, key, and the like.

In the rotary type Stirling engine 10 for green growth according to this embodiment, the baffle 40 is coupled to the outer circumference of the rotor 30 in such a manner as to be arranged equidistantly in a circumferential direction of the rotor 30 so that the inner space 21 is partitioned into a plurality of regions by the baffle 40 to allow the heat transfer medium to be uniformly received in the regions. In addition, the baffle 40 is coupled to the outer circumference of the rotor 30 in such a manner as to be variable with respect to the rotary center C2 of the rotor 30 in a radial direction of the rotor 30 so that the baffle is maintained in a stat of being in close contact with the inner circumferential surface 22 of the housing 20 and the inner space 21 is partitioned into a plurality regions by the baffle 40 to cause working fluid received in one of the partitioned regions to be prevented from flowing into another partitioned region. When it is rotated by the heat transfer medium, such a baffle 40 continues to be maintained in a state of being close contact with the inner circumferential surface 22 of the housing 20 while extending elastically in a radial direction with respect to the rotor 30 so that the heat transfer medium contained in each partitioned zone of the inner space is prevented from leaking into another partitioned zone.

Meanwhile, the heat transfer medium used in the rotary type Stirling engine 10 for green growth according to this embodiment preferably employs gas having a small molecule size such as helium, hydrogen, or the like, but may be set to various compression ratios to set a desired heat transfer medium and the number of baffles 40 depending on the need of a designer or user under the technical spirit of the present invention. In this case, as the volume ratio of the partitioned spaces is high, a difference in the pressure of the heat transfer medium is increased, so that the sealing force between the baffle 40 and the inner circumferential surface 22 of the housing 20 is decreased. Thus, the volume ratio of the partitioned spaces is preferably made as small as possible, and the thermal efficiency is increased as the eccentricity amount, Δl is large.

By virtue of this construction, the rotary type Stirling engine 10 for green growth according to the present invention enables heating and cooling to be continuously performed on the outer circumferential surface 24 of housing 20 based on the reference central axis CL so that the heat transfer medium sealingly received in the inner space 21 of the housing 20 is expanded and contracted to forcibly push the baffle 40 to thereby produce power for rotating the output shaft 12 (in an arrow direction indicated by a doted line of FIG. 1) through the rotor 30.

The rotary type Stirling engine 10 for green growth according to the present invention allows for a heating operation, i.e., a process in which one side of the housing receives heat from the outside and is expanded (see the right in FIG. 1) and a cooling operation, i.e., a process in which the other side of the housing loses heat to the outside (see the left in FIG. 1) is contracted based on the reference central axis CL within a sealed predetermined space. In this case, the partitioned space where the heat transfer medium is received has a structure in which the expanded portion (i.e., heating region) and the contracted portion (i.e., cooling region) are symmetrical to each other based on the reference central axis CL, and the output shaft is in a state of being eccentric. At this time, the deviation of the output shaft is performed on the contracted portion. That is, as shown in FIGS. 1 and 2, the eccentric direction of the output shaft is positioned on the reference central axis CL passing by the contracted portion (i.e., the cooling region) where heat is lost to the outside. Thus, the rotation of the output shaft 12 is performed in a direction in which the output shaft is deviated so that the output shaft is resultantly rotated from the heating region to the cooling region.

By virtue of this construction, the rotary type Stirling engine 10 for green growth according to the present invention is very simple in structure since it does not have a construction in which the heat transfer medium is circulated. Thus, since the capacity of the Stirling engine can be changed by easily controlling the length of the number of the Stirling engine 10 in a lengthwise direction of the output shaft 12 depending on the need, the Stirling engine can be easily and simply applied in various environments. Particularly, the necessity of a piping for circulating the heat transfer medium is eliminated, so that simplicity of the device can be achieved, convenience of maintenance/repair can be improved, and the thermal efficiency can be increased.

### INDUSTRIAL APPLICABILITY

The rotary type Stirling engine 10 for green growth according to the present invention can be applied to power plant facilities employing waste heat generated from a purification facility of a petrochemical plant, waste steam generated from a thermal power station, and radiation of a nuclear power plant, a desert where scorching direct sunlight pours down and the temperature of air is relatively low, a place where radiant heat is strong and the temperature is low, and the like.

1. A rotary type Stirling engine for green growth, in which power is produced using a change in the pressure of a heat transfer medium occurring by continuously performing a periodic heating and cooling in a state in which the heat transfer medium is stored in a sealed inner space 21, the Stirling engine comprising:
a hollow cylindrical housing 20 having an inner circumferential surface 22 defining the inner space 21 therein and an outer circumferential surface 24, and comprising an output shaft 12 coupled thereto so as to extend outwardly therefrom to have an eccentricity amount Δl on a reference central axis CL, the output shaft being configured to allow power produced to be transferred to the outside and the housing being hermetically sealed to prevent the heat transfer medium stored in the inner space 21 from leaking to the outside;
a rotor 30 coupled to the output shaft 12 within the housing 20; and
a baffle 40 coupled to the outer circumference of the rotor 30 in such a manner as to be arranged equidistantly in a circumferential direction of the rotor 30 so that the inner space 21 is partitioned into a plurality of regions by the baffle to allow the heat transfer medium to be uniformly received in the regions, the baffle being coupled to the outer circumference of the rotor 30 in such a manner as to be variable with respect to the rotary center C2 of the rotor 30 in a radial direction of the rotor 30 so that the baffle is maintained in a stat of being in close contact with the inner circumferential surface 22 of the housing 20 and the inner space 21 is partitioned into a plurality regions by the baffle 40 to cause working fluid received in one of the partitioned regions to be prevented from flowing into another partitioned region,
whereby heating and cooling are performed on the outer circumferential surface 24 of the housing 20 based on the reference central axis CL so that the heat transfer medium sealingly received in the inner space 21 of the housing 20 is expanded and contracted to forcibly push the baffle 40 to thereby produce power for rotating the output shaft 12 through the rotor 30.

2. The rotary type Stirling engine for green growth according to claim 1, wherein the rotor 30 comprises one or more recesses 36 formed therein in such a manner as to be arranged in parallel with a radial direction of the center C2 of the rotor 30, and the baffle 40 comprises one or more blades 42 and one or more elastic element 44 each of which is connected to each blade, each blade 42 being brought into close contact at one end thereof with the inner circumferential surface of the housing 20 and being inserted at the other end thereof into the recess 36 of the rotor so that the blade is slidingly coupled to the rotor 30 in a radial direction of the rotor, and each elastic element 44 being disposed in the recess so that an elastic force generated by the elastic element 44 acts on the blade 42 to cause the blade to be forcibly pushed and come into close contact with the inner circumferential surface 22 of the housing 20.

3. The rotary type Stirling engine for green growth according to claim 1, further comprising a heat exchange division member 60 configured to divide an outer space defined on the outer circumference of the housing 20 into a heating region 61 for performing a heating operation and a cooling region 61′ for performing a cooling operation based on the reference central axis CL.

4. The rotary type Stirling engine for green growth according to claim 3, wherein the housing 20 further comprises a plurality of heat radiating fins 28 and 72 extending protrudingly radially from the outer circumferential surface 24 thereof in such a manner as to be spaced apart from one another at equal intervals.

5. The rotary type Stirling engine for green growth according to claim 2, further comprising a heat exchange division member 60 configured to divide an outer space defined on the outer circumference of the housing 20 into a heating region 61 for performing a heating operation and a cooling region 61′ for performing a cooling operation based on the reference central axis CL.
